(19) United States
(12) Patent Application Publication
(10) Pub. No.: US 2002/0080002 A1
(43) Pub. Date: Jun. 27, 2002

(54) Microwave inductor with poly-iron core configured to limit interference with transmission line signals

(76) Inventors: William W. Oldfield, Redwood City, CA (US); Richard Simmons, San Jose, CA (US)

Correspondence Address: MARTIN C. FLIESLER, FLIESLER DUBB MEYER & LOVEJOY LLP, Fourth Floor, Four Embarcadero Center, San Francisco, CA, 94111-4156, US

(21) Appl. No.: 10/080,343

(22) Filed: Feb. 21, 2002

Related U.S. Application Data
(63) Continuation-in-part of application No. 09/027,087, filed on Feb. 20, 1998.
(60) Provisional application No. 60/294,311, filed on May 29, 2001.

(51) Int. Cl. H01F 27/28

(52) U.S. Cl. 336/231

(57) ABSTRACT

An inductor coil is made with windings turns in a conical shape tapered from a very small diameter and gradually increasing. The core of the coil is composed of a dielectric material with a colloidal suspension of magnetic particles, i.e. poly-iron. The core functions to increase impedance at higher frequencies to reduce resonant loss glitches, while providing a low impedance at low frequencies to provide a high Q at low frequencies. The core can be part air (or non-magnetic dielectric) and part poly-iron, with the air portion provided closest to a transmission line where the inductor is connected to prevent the core from interfering with the magnetic field of signals on a transmission line.

### CROSS-REFERENCE TO PROVISIONAL APPLICATION

This Patent Application claims the benefit of Provisional Application No. 60/294,311 filed May 29, 2001.

### CROSS-REFERENCE TO RELATED NON-PROVISIONAL APPLICATION

This application is a continuation-in-part of application Ser. No. 09/027,087, filed Feb. 2, 1998, entitled “Lumped Element Microwave Inductor With Windings Around Tapered Poly-Iron Core.”

### BACKGROUND OF THE INVENTION

1. Field of the Invention

The present invention relates to microwave inductors for use over a wide bandwidth from low to high frequency microwave applications, and more particularly to microwave inductors having tapered coil windings with a poly-iron core.

2. Background

U.S. patent application Ser. No. 09/027,087 (the '087 application) entitled a “Lumped Element Microwave Inductor With Windings Around A Tapered Poly-Iron Core” describes an inductor made from wire wound in a conical shape with an interior core portion filled with poly-iron. FIG. 1 shows such a conical shaped inductor 100 connected to a microstrip transmission line 110.

As shown by FIG. 2, a cutaway of the inductor of FIG. 1, the core material 200 of the inductor 100, as described in the '087 application, fills the windings 202 of the coils of the inductor 100. The suggested core material, poly-iron, is a material made from iron powder mixed with epoxy binding material. But, other core materials made from a powdered magnetic material suspended in a dielectric binder, forming a colloidal suspension of magnetic particles, are also described in the '087 application as suitable. For convenience, the inductor 100 carried over from FIG. 1 to FIG. 2 is similarly labeled, as will be components carried over in subsequent drawings.

The conical shaped inductor with a poly-iron core is described in the '087 application for use as an element in a filter, or as a bias coil or choke for injecting current into a transmission line of a circuit without disturbing the impedance of a transmission line. The two major applications of inductive coils, filter elements and bias lines have different requirements. Good filter structures require high Qs, necessitating inductors which are not lossy due to a high resistance. A bias coil merely has to look like a high impedance to a line impedance, and the Q is unimportant. For high frequency microwave applications, it is, thus, desirable for an inductor which does not experience significant resonant losses and which operates over a wide bandwidth while providing a high Q.

A coil with a solid ferrite core will have much higher inductance than a coil without a core, but generally intercoil capacitance will increase and the self resonant frequency (SRF) of the coil will occur at a much lower frequency. The SRF, or glitches, occur at frequencies where the insertion loss through the coil will be significant. Poly-iron is a material that serves to both increase the inductance of the coil and dampen resonances at the SRF in the coil. Resonances are eliminated because the poly-iron absorbs and attenuates the high frequency electromagnetic fields generated in the inductor. Elimination of resonances allows the inductor to provide a high impedance over a wide frequency range of at least 10 MHz to 65 GHz. With the poly-iron core, the inductor will further have a low resistive loss at low frequencies enabling the coil to have a high Q.

With the coil windings turns tapered to form a conical shape, resonant loss is also reduced relative to inductors with uniform diameter windings. With uniform diameter windings, each coil winding and its associated intercoil capacitance resonates at a common frequency. However, with a tapered coil, each winding and its associated intercoil capacitance is slightly different, and resonant losses are much less pronounced.

The conical inductor with a poly-iron core is used by connecting the small end of the winding 102 to a microstrip or coaxial transmission line, such as the microstrip transmission line 110. The best insertion loss performance is obtained with the inductor tip, or small end 102, attached as close as practical to the transmission line 110. Because the inductor 100 is positioned very close to the transmission line 110, the poly-iron core 200 interferes with not only the electromagnetic fields in the inductor 100, but also the electromagnetic fields 300 in the transmission line 110, as illustrated in FIG. 3. Interference with the electromagnetic fields 300 contributes to an increase in insertion loss in the transmission line 110.

### SUMMARY

In accordance with the present invention, a conical shaped inductor is provided with wire wound around a core containing a colloidal suspension of magnetic particles, such as poly-iron. To prevent interference with magnetic or electric fields on a transmission line, the magnetic core material is provided in only one portion of the coil. The portion of the core occupied by the magnetic material is farthest from the narrowest diameter windings, the typical connection point for the coil to a transmission line. Removing some poly-iron at the narrow tip of the inductor eliminates the interference with an electromagnetic field in close proximity to the transmission line. With magnetic material only occupying a portion of the inductor coil, the transmission line loss where the coil is connected can be reduced by as much as 3 dB.

### BRIEF DESCRIPTION OF THE DRAWINGS

The present invention will be described with respect to particular embodiments thereof, and references will be made to the drawings in which:

FIG. 1 shows such a conical shaped inductor connected to a microstrip transmission line;

FIG. 2 shows a cutaway drawing of the inductor of FIG. 1 showing how the core material fills the windings;

FIG. 3 illustrates interference of the core of the inductor of FIG. 2 with the electromagnetic fields of a transmission line;

FIG. 4 illustrates a cutaway view of a microwave inductor in accordance with the present invention as connected to a microstrip transmission line;

FIG. 5 illustrates losses in a signal on a transmission line with an attached conical shaped inductor having a poly-iron core filling all of the windings; and

FIG. 6 illustrates losses in a signal on a transmission line with an attached conical shaped inductor having a poly-iron core partially filling the windings.

### DETAILED DESCRIPTION

FIG. 4 illustrates a cutaway view of a microwave inductor 400 in accordance with the present invention as connected to a microstrip transmission line 410. The inductor 400 is composed of a coil of wire having winding turns 202 with diameters tapered from a first diameter φ₁ at one end of the coil to a second diameter φ₂ at a second end of the coil. The inductor 400 further includes a core, with a portion of the core 404 comprised of a colloidal suspension of magnetic particles, the core material preferably being poly-iron. The portion 404 of the core occupied by the magnetic material is farthest from the narrowest diameter windings, the typical connection point for the coil to a transmission line. Removing some poly-iron at the narrow tip, leaving a portion 406 without magnetic material, eliminates the interference of electromagnetic field 300 of a signal on the transmission line 102 by magnetic material in the inductor.

As indicated previously, the tapered coil is preferable because each winding diameter and its associated intercoil capacitance is slightly different, and resonant losses are much less pronounced. As an example, an inductor in accordance with the present invention can have windings with diameters tapered from φ₁=0.020 inches to φ₂=0.060 inches, with 60 turns of 47 gauge wire.

Further, as indicated previously, a material is used for the core portion 404 which can enable a high inductance as well as provide a high Q at lower frequencies and a high resistance at higher frequencies. At high microwave frequencies, a magnetic core with suspended magnetic particles will be needed to reduce intercoil capacitance so that low frequency SRF loss glitches do not occur. At low microwave frequencies, a magnetic core with suspended magnetic particles will further have a low resistive loss enabling the coil to have a high Q. By providing a high Q at low frequencies, and a high resistance at higher frequencies, an inductor is useful both as a bias line and a filter element.

The magnetic particles used in the core portion 404 could include iron powder, or other ferromagnetic particles. However, ferrite particles are less desirable than pure iron powder because the permeability of the ferrite particles will change as current is applied, causing the impedance of a coil with a ferrite particle core to change more significantly with the amount of applied current than a coil having an iron powder core. The magnetic flux provided from the magnetic particles also greatly increases the inductance of a coil. With a tapered coil using a poly-iron core, an inductor can function from as low as 10 MHz through typical SRF ranges of 3-5 GHz to frequencies higher than 60 GHz.

The dielectric material used in the core portion 404 maybe a polymeric material such as an epoxy resin, or a crystalline material such as glass. The dielectric material, such as epoxy, serves to coat each magnetic particles so that the particles are not in direct contact with each other, but are capacitively coupled. Being separated, the magnetic particles do not conduct electrical signals at DC or low frequencies, unlike a solid ferrite core typically provided in an inductor, but with inductive coupling even though the particles are separated they will conduct electrical signals as frequency increases. Therefore, the dielectric material with a colloidal suspension of magnetic particles can provide little loss at low frequencies and can also provide a high loss at high frequencies, as desired.

The percentage of magnetic particles relative to the dielectric material making up the core material 404 for the coil can be varied to control the inductance value of the coil. For example, if a low inductance is desired, the core material 404 could include less than 5% by volume magnetic particles to greater than 95% by volume dielectric material. If a high inductance is desired, the poly-iron material could include greater than 90% by volume magnetic particles to less than 5% by volume dielectric material.

To manufacture the inductor 400, wire is initially wound in a toroidal fashion around a tapered mandrel. An adhesive can then be applied to the wire to bind the windings together, and the wire can then be removed from the mandrel. The wire can also have an adhesive material coating its outer surface prior to being wound on the coil, and then immersed in a solvent which activates the adhesive causing the windings to be bound together before the coil is removed from the mandrel.

To manufacture the core, with epoxy used as the dielectric material for the core, the epoxy can be mixed with the appropriate percentage of magnetic material and then poured into the center of the windings for the coil. To prevent the magnetic material from flowing into the small tip of the core, a small glass bead can be placed in the core prior to pouring in the epoxy mixed with iron powder. The viscosity of the epoxy can be controlled to prevent the epoxy and powdered iron mixture from passing the glass bead. Alternatively to prevent the magnetic material from flowing into the small tip of the core, epoxy without iron powder can be poured into the small tip and cured prior to pouring in epoxy with the iron powder mixed in. Temperature, or the material content of the epoxy can be controlled so that the viscosity of the epoxy enables the epoxy to cure within the center of the windings of the coil without running out. Preferably, the core material 404 is cured at atmospheric pressure, and temperature is elevated above room temperature to accelerate the curing time. The core further preferably does not extend past the windings at the larger end of the inductor.

The inductor coil wire 202 is specially prepared insulated wire with the insulation removed at the ends. The lead 102 at the small end of the coil should be free of insulation to within a distance from the first winding of the coil of no greater than twice the inner diameter of the small end of the coil, so that the lead length is minimal for the highest frequency operation. The uninsulated ends or leads 102 and 420 of the wire may be plated with tin, solder, or gold. The leads can be attached by reflow soldering or by the use of conductive epoxy.

The wire leads 102 and 420 can be half the diameter of a human hair, or from about 0.0008 to 0.0015 inch in diameter. This makes them extremely fragile. When the wire is #36 gauge (AWG), and the small end of the coil is 0.016″ inner diameter, the device will operate well to above 12 GHz with about 600 ma current capacity. When the wire is #47 AWG, and the small end of the coil is 0.005″ inner diameter, the device will operate well above 60 GHz with about 100 ma of current capacity.

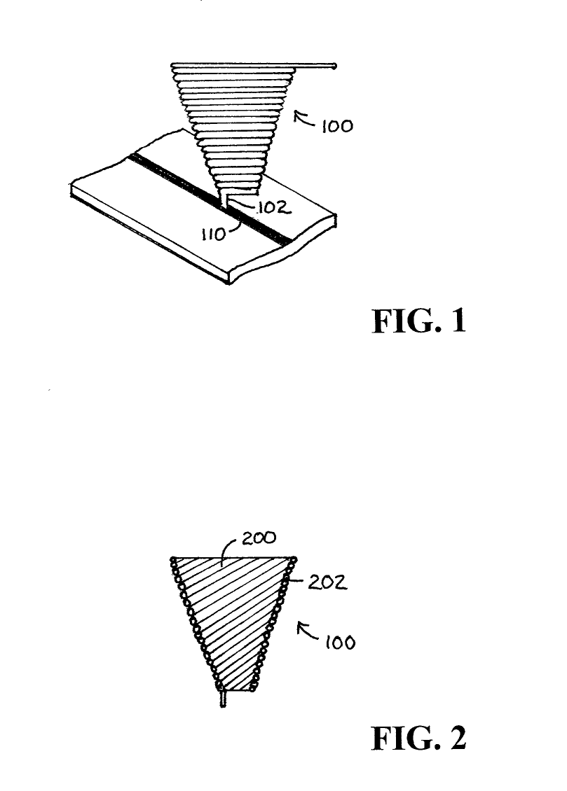

The small end of the coil is in one embodiment separated from a transmission line by less than ½ of the inner radius of the small end of the coil. Although the separation from a transmission line and removal of insulation is described as improving performance for the inductor of FIG. 4, improved performance in accordance with the present invention is likewise achieved with the inductor of FIGS. 1-3. Further, although FIG. 4, shows the inductor 400 oriented orthogonal to the microstrip line 102, the inductor may have its central axis (the central axis running through the center of the winding turns) tilted to an angle substantially less than 90° from the plane of the microstrip line to enable easier packaging, or to prevent interference by the inductor with other components.

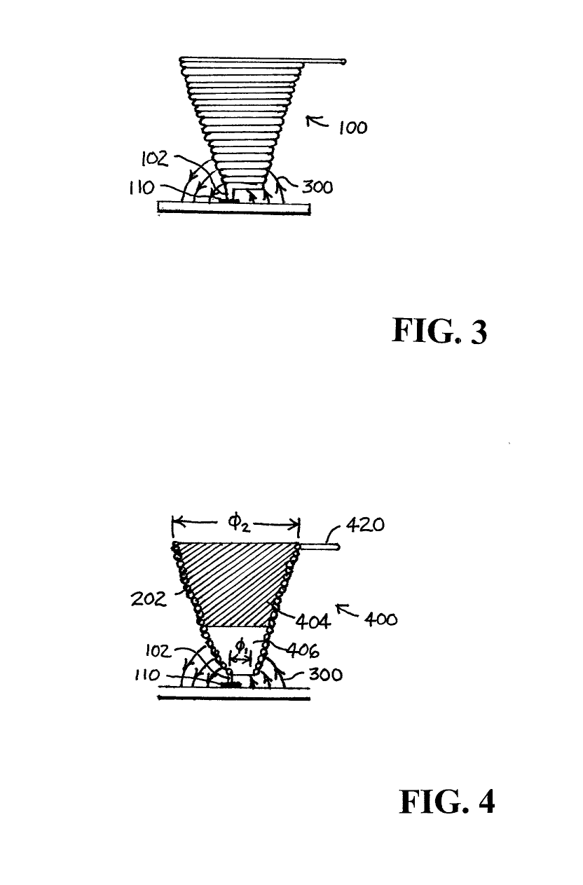

The inductor coil wire and the core intersect the RF fields of signals on the microstrip line which causes two problems: (1) The metal of the coil wire and the dielectric of the core material cause increased capacitance on the transmission line resulting in an unwanted reflection (this is the reason that the coil winding diameters are preferably kept very small at the RF connection end; and (2) The poly-iron core is a lossy medium which when inserted into the microstrip fields causes undesired loss. Losses due to interference with magnetic fields 300 on the transmission line 100, as illustrated in FIG. 3, increase with frequency and become appreciable at higher frequencies.

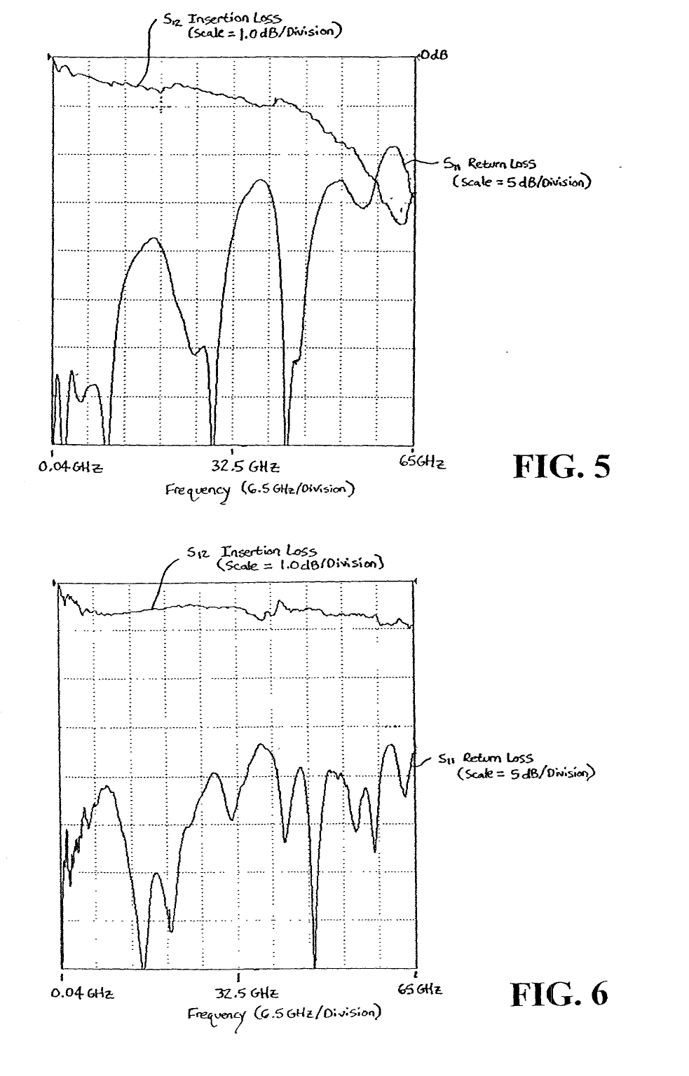

FIG. 5 illustrates losses in a signal on a transmission line with an attached conical shaped inductor having a poly-iron core filling all of the windings. The measurements were made with a Vector Network Analyzer over a frequency range from 40 MHz to 65 GHz. As shown, at 65 GHz S₁₂insertion losses on the transmission line are nearly −3 dB, while S₁₁ return losses are as are as high as −10 dB at approximately 65 GHz.

With the magnetic core not located where it can cause interference with electromagnetic fields, as with the inductor 400 of FIG. 4, reduced losses will occur in a signal on the transmission line. The improvement can significantly decrease the losses of the inductor, as illustrated in FIG. 6. In FIG. 6, measurements were made with a VNA over the 40 MHz to 65 GHz range. As shown, at 65 GHz S12 insertion losses remain above −1 dB for the entire frequency range, an improvement of over 2 dB from FIG. 5 for some frequencies. Further the S11 return losses remain below −15 dB for the entire frequency range, an improvement of over 5 dB from FIG. 5 for some frequencies.

Although the present invention has been described above with particularity, this was merely to teach one of ordinary skill in the art how to make and use the invention. Many other modifications will fall within the scope of the invention, as that scope is defined by the claims provided to follow.

What is claimed is:

1. An inductor comprising:
a coil of wire having winding turns with diameters tapered from a first small diameter end to a second large diameter end; and
a conical shaped core provided in the coil of wire, the core comprising dielectric material supporting magnetic particles forming a colloidal suspension of the magnetic particles,
wherein the core fills the center of a number less than all of the winding turns.

2. The inductor of claim 1,
wherein the core fills the center of the winding turns for a number of turns from the second large diameter end toward the first smaller diameter end.

3. The inductor of claim 2,
wherein the core does not extend substantially past the second large diameter end.

4. The inductor of claim 1,
wherein the core is not provided within the winding turns for a number of turns from the first small diameter end.

5. The inductor of claim 1,
wherein the core does not fill the center of the winding turns after a number of turns from the first small diameter end.

6. The inductor of claim 1,
wherein the colloidal suspension of magnetic particles comprises poly-iron.

7. The inductor of claim 1,
wherein small and large diameter ends of the coil of wire have ends extending as first and second leads respectively; and
wherein the first lead is free of insulation within a distance from the small end of the coil no greater than twice an inner diameter of a winding of the small end of the coil.

8. The inductor of claim 1, wherein a small end of the coil of wire is displaced from a transmission line by a distance of less than ½ of an inner radius of a winding at the small end of the coil of wire.

9. The inductor of claim 1, wherein a large end of the coil is displaced from a transmission line by a distance of greater than ½ of a radius of a winding at the large end of the coil of wire.

10. An inductor comprising:
a wire having first and second ends,
wherein the wire is wound into a hollow conic coil, the coil having a small end and a large end, the small and large ends of the coil having inner and outer diameters;
wherein the small and large ends of the wire extend as first and second leads respectively;
a coating of electrical insulation on the wire, except on the leads,
wherein the first lead is free of insulation within a distance from the small end of the coil no greater than twice the inner diameter of the small end of the coil;
a core comprising powdered iron bound with an adhesive binder partially filling the windings of the coil.
